(19) United States
(12) Patent Application Publication
(10) Pub. No.: US 2005/0000700 A1
(43) Pub. Date: Jan. 6, 2005

(54) Fire extinguishing method and apparatus

(76) Inventor: Goran Sundholm, Tuusula (FI)

Correspondence Address: LADAS & PARRY, 26 WEST 61ST STREET, NEW YORK, NY, 10023, US

(21) Appl. No.: 10/497,384

(22) PCT Filed: Dec. 31, 2002
(86) PCT No.: PCT/FI02/01060

(30) Foreign Application Priority Data
Jan. 2, 2002 (FI) 20020001

(51) Int. Cl. A62C 2/00; A62C 3/00

(52) U.S. Cl. 169/43; 169/45; 169/46

(57) ABSTRACT

A fire extinguishing method, especially for relatively high spaces (1), such as the engine rooms of ships, in which method a mist of extinguishing medium and a gas are suplied into the space. The mist of extinguishing medium is supplied into the space (1) via at least one first nozzle (2) provided in its upper part, in an unevenly distributed manner so that a circulating motion of the mist of extinguishing medium is created in the space. The invention also relates to a fire extinguishing apparatus.

### BACKGROUND OF THE INVENTION

The present invention relates to a fire extinguishing method as defined in the preamble of claim 1, especially for relatively high spaces, such as e.g. the engine rooms of ships, in which method a mist of extinguishing medium and a gas are supplied into said space.

The invention also relates to a fire extinguishing apparatus as defined in the preamble of claim 11 especially for relatively high spaces, such as the engine rooms of ships, said apparatus comprising means for supplying an extinguishing medium to at least one first nozzle, from which a mist of extinguishing medium is sprayed into the space in question, and means for supplying a gas into said space.

In relatively large spaces, extinguishing especially small fires using a mist of an extinguishing medium, such as water mist, has proved to be problematic. The worst problems are encountered in cases where the mist of fire extinguishing medium cannot be applied directly to the seat of fire. Such spaces typically include e.g. ships' engine rooms, especially where no directly targeted extinguishing method is not used.

There are also prior-art solutions in which high spaces are protected against fire by using only gas systems in which the space is supplied with a gas, such as carbon dioxide, inert gas, e.g. a mixture of argon, nitrogen and carbon dioxide or a mixture of argon and nitrogen. Gas systems have the drawback that they require a closed space. For example, if a door of the space to be protected is left open, then it is not possible to create a gas concentration necessary for putting out a fire. This may lead to complete destruction of the property to be protected. In the concentrations used, many gases are noxious, even lethal to people. For this reason, a delay Is needed between the moment of detection of fire and the start of the extinguishing operation, during which delay people can get out of the space where a fire is to be extinguished, whereupon the space is closed. This delay may be fairly long, even tens of minutes, during which time the fire may cause considerable damage.

In addition, gas systems have no cooling effect on the surroundings, and they have a poor ability to extinguish smoldering fires.

WO specification 93/09848 discloses a fire extinguishing method whereby a mixture of water spray or water mist and a gas is supplied into a closed space where a fire is to be extinguished. The gas concentrations in this space are kept at a level that is not a risk to human life. This solution brings many advantages as compared to an exclusively gas-based system. However, the solution according to this specification is only designed for closed spaces from where the gas cannot escape and where the fire itself consumes oxygen. A further problem is that the water mist is not evenly distributed in the space, and consequently the. solution is not sufficiently effective in extinguishing hidden fires, especially in so-called open spaces.

### SHORT DESCRIPTION OF THE INVENTION

The object of the present invention is to achieve a completely new type of solution for extinguishing fires especially in large open spaces, in which solution the nozzles for spraying an extinguishing medium can be disposed at a relatively large distance from the target to be protected, e.g. in the upper part of a space having a height exceeding 5 meters, typically at the ceiling or in its vicinity. Another object is to achieve a solution that makes it possible to extinguish even hidden fires in relatively large spaces. In short, the aim is to achieve a solution for fire protection in high spaces, such as the engine rooms of ships.

The invention is based on a fire fighting concept implemented by combining the use of a mist of fire extinguishing medium, such as water mist, and a gas, in concentrations that pose no risk to human life, and creating a circulation of the extinguishing medium so as to achieve a good distribution and mingling of the extinguishing medium in the space.

The method of the invention is mainly characterized in that the supply of the mist of extinguishing medium into the space occurs via at least one first nozzle provided In the upper part of the space, in a manner such that the mist is unevenly distributed so that a circulating motion of the mist of extinguishing medium is created in the space.

The method of the invention is additionally characterized by what is stated in claims 2-10.

The apparatus of the invention is characterized in that the apparatus comprises at least one first nozzle disposed in the upper part of the space and at least one second nozzle disposed in the space for supplying a gas and/or a mist of extinguishing medium into the space so as to allow a circulation of the mist of extinguishing medium to be produced in the space.

The apparatus of the invention is additionally characterized by what is stated in claims 12-20.

The solution of the invention has numerous significant advantages. By utilizing the circulation of extinguishing medium created in the space together with a gas supplied into the space to reduce the oxygen content, a very good degree of mingling is achieved, with the result that a good extinguishing result is achieved even in the case of hidden fires.

The solution of the invention is well applicable for use in partially open spaces as well. In this case, the nozzles for extinguishing medium can be disposed in the upper part of the space to be protected, at a large distance from objects subject to a potential risk of fire. The method of the invention is very well applicable for use in high spaces. The nozzles for the extinguishing medium can be placed at a distance of over 5 meters from the floor. Some of the nozzles may be initially used for the supply of gas and, when the gas supply diminishes and/or runs out, for the spraying of extinguishing medium as well. In this way, an advantageous technical solution is achieved while the effects of the liquid mist can be maximized at least at the final phase of the fire extinguishing process. By spraying the liquid mist under a high pressure and using an appropriate spraying head, a good penetrating power of the liquid mist is obtained, which brings an advantage especially in the case of distant fire seats to be extinguished. Connecting the pipe systems used for the supply of extinguishing liquid and gas together gives the possibility to simply and automatically admit liquid to the gas supplying second nozzles after the gas pressure has fallen and the supply of gas has stopped. By using a shut-off/control element, e.g. a pressure valve or throttle in the pipe system, it is possible to exert an Influence on the pressure difference between the first and the second nozzles and/or on the flow and thereby on the circulation of the mist of extinguishing medium in the space.

### SHORT DESCRIPTION OF THE FIGURES

In the following, the invention will be described in detail with reference to the attached drawing, wherein

FIG. 1 presents a simplified view of an arrangement according to the invention.

FIG. 2 visualizes the disposition of the nozzles used in the solution, represented by FIG. 1 as seen from above.

FIG. 3 represents another arrangement according to the invention.

### DETAILED DESCRIPTION OF THE INVENTION

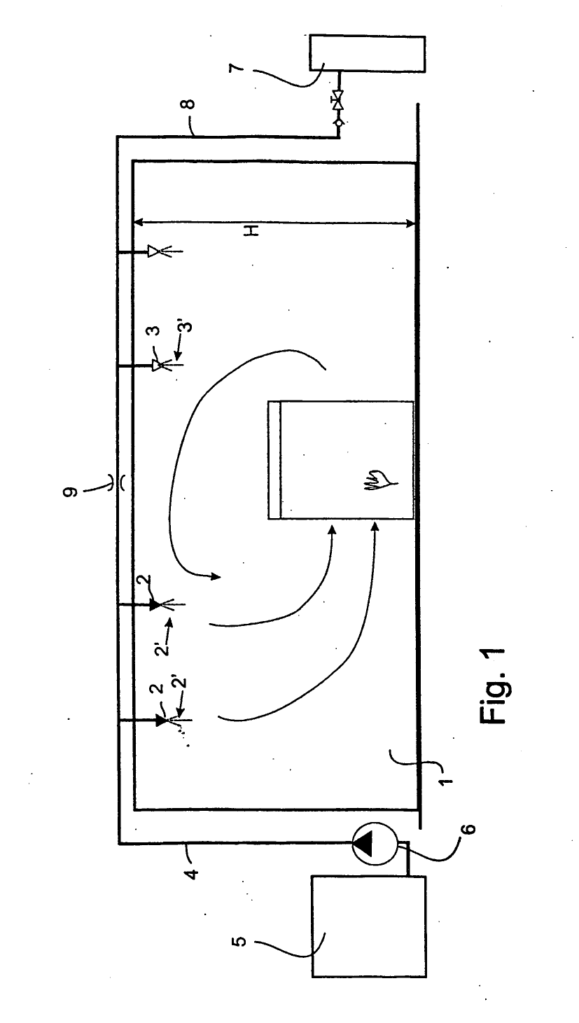

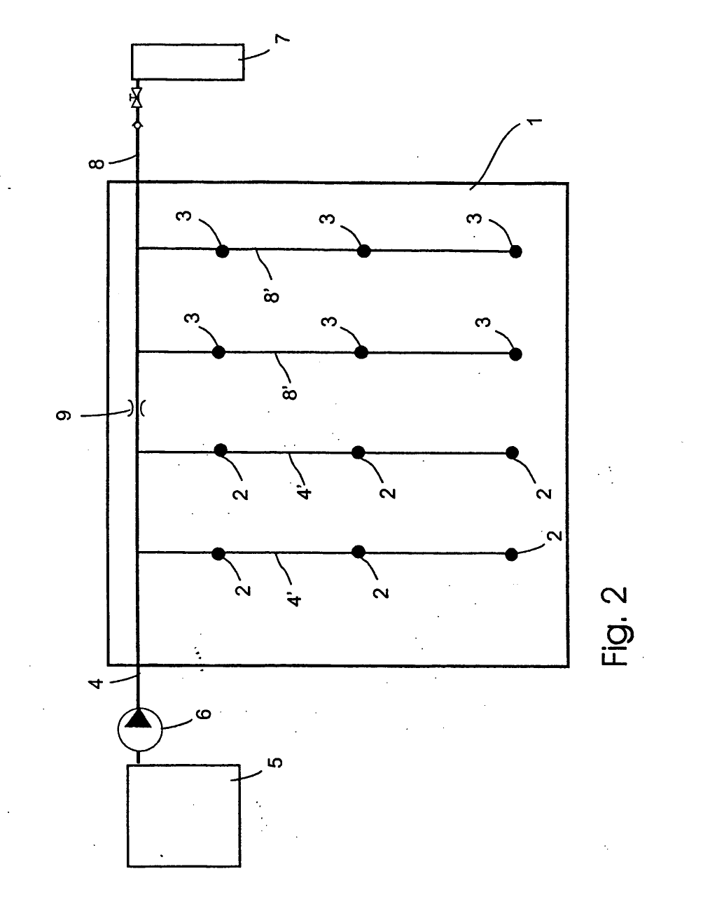

FIGS. 1 and 2 present a fire extinguishing system according to the invention in a simplified form. The space 1 to be protected by the extinguishing system is relatively large, preferably a space with a large height, such as e.g. the engine room of a ship. Disposed in the upper part of the relatively large space is at least one first nozzle 2 for spraying a mist of extinguishing medium into the space to be protected and means for conveying an extinguishing medium to the nozzle. These means comprise a pipe system 4 or equivalent, a source 5 of extinguishing medium and means, such as e.g. a pump 6, for bringing the extinguishing medium to the nozzle. The system comprises at least one second nozzle 3, which in the figure is also disposed in the upper part of the space 1. The system comprises a source 7 of gas, such as at least one gas bottle, from which a gas can be conveyed to the space 1 via a nozzle, e.g. at least one second nozzle 3. The gas is passed to the nozzle 3 via a pipe 8. The nozzles 2, 3 are preferably disposed in the ceiling of the space 1 or in its vicinity as shown in FIG. 1 and 2. In the figures, the respective pipe systems 4, 8 for the first nozzles 2 and the second nozzles 3 are connected together and the pipe 4, 8 between them is provided with an element, such as a valve device or throttle 9, for exerting an influence on the pressure and/or flow. By means of this element, the pressure in the second nozzles 3, at least for the spraying of liquid, is adjusted to a level below the pressure in the first nozzles 2. In FIG. 2, the pipe system connecting the first nozzles to the source 5 of extinguishing medium is indicated by reference numbers 4, 4′ and the pipe system connecting the second nozzles by reference numbers 8, 8′.

The present invention relates to a fire extinguishing method especially is for relatively high spaces 1, such as the engine rooms of ships, in which a mist of fire extinguishing medium and a gas are supplied into the space. The invention is characterized in that that the mist of extinguishing medium is supplied into the upper part of the space 1 via at least one first nozzle 2 in a manner such that the mist is unevenly distributed so that a circulating motion of the mist 2′ of extinguishing medium (arrows in FIG. 1) is created in the space. Via suitable disposition of the nozzles 2, 3 in the space and/or via pressure differences and/or penetration differences produced between the extinguishing mediums sprayed, an unbalance is created that, together with the suction generated by high-pressure spraying, produces a circulation of the mist of extinguishing medium in the space. According to an embodiment of the invention the circulation “goes against” the spray from at least one of the spray heads, due to the spray from another of the spray heads being more energetic.

According to the invention, the mist of extinguishing medium, especially liquid mist, is sprayed via at least one nozzle 2 disposed in the upper part of the space 1 and a gas is supplied into the space 1 via at least one second nozzle 3 and/or at least one third nozzle 10. According to a preferred embodiment, gas is supplied into the space at least at the early stage of the extinguishing process. As the gas has a lower penetrating power than the liquid mist, this contributes towards creating a circulating motion, which is indicated by arrows in FIG. 1. Supplying gas into the space reduces the oxygen content in it and thus facilitates the extinction of fire. The pressure of the gas supplied into the space 1 is decreased as the extinguishing process is going on. The gas is typically an inert gas (non-reactive), such as nitrogen or a non-combustible mixed gas. Once the oxygen content in the space has fallen to a desired value, the supply of gas into the space can be stopped while the extinguishing process is going on. Typically the supply of gas is stopped at a point during the extinguishing process. The supply of gas can be implemented using e.g. one or more pressure vessels, such as gas bottles. As the extinguishing process is going on, liquid mist is supplied into the space in a more evenly distributed manner than at first via the nozzles disposed in the upper part of the space.

According to a preferred embodiment of the invention, at least a number of the second nozzles 3 are used for supplying liquid mist into the space simultaneously with gas and/or after the supply of gas through them has stopped. According to a preferred embodiment, the liquid for the liquid mist and the gas are fed into the same pipe system 4, 8 from opposite directions. The extinguishing medium Is supplied to the nozzles in an unevenly distributed manner so that the extinguishing medium is fed to a number of nozzles 2, 3 at a substantially lower pressure than to the first number of nozzles. This can be accomplished by using different sources of supply or e.g. a throttle in a part of the pipe system.

Liquid mist is sprayed into the space 1 at a high pressure. The operating unit 6 may be e.g. a constant-pressure pump. The pressure in the pipe system is typically over 30 bar, preferably over 50 bar, most preferably over 70 bar. The liquid mist produced by the nozzles Is typically very fine, with a typical droplet size (Dᵥ₉₀) below 400 micrometers, preferably below 300 micrometers, most preferably below 200 micrometers. At least some of the first nozzles 2 are of a type that produces a concentrated mist of extinguishing medium as a spray that has a good penetrating power. The principles of a nozzle solution applicable for use in the solution of the invention and allowing the desired properties to be achieved are described in published international patent application WO 92/20453. The means used for the supply of a mist of extinguishing medium and gas are assumed to be obvious to the skilled person, so they will not be described here in detail.

At least at the early stage of the extinguishing process, the oxygen content in the space is typically reduced to a value of about 15%. The oxygen content may typically vary e.g. between 8% and 19%. The essential point is that, at least at the early stage of the extinguishing process, the oxygen content is limited to a level that is not harmful to people if exposed to it for a short time.

The invention also relates to a fire extinguishing apparatus especially for relatively high spaces 1, such as the engine rooms of ships, said apparatus comprising means 4, 5, 6 for supplying a fire extinguishing medium at a high pressure to at least one first nozzle 2, from which a mist of extinguishing medium is sprayed at a high pressure into the space 1. The at least one first nozzle 2 is disposed in the upper part of the space 1 and the apparatus comprises at least one second nozzle disposed in the space for supplying a gas into the space so that a circulation of the mist of extinguishing medium can be created in the space. According to a second preferred embodiment, circulation of extinguishing medium can be set up at least at the early stage of the extinguishing process. By disposing the first nozzles 2 in the space 1 in an unsymmetrically distributed manner at least in one vertical cross-section of the space, an advantageous arrangement enabling circulating currernts of the mist of extinguishing medium to be set up.

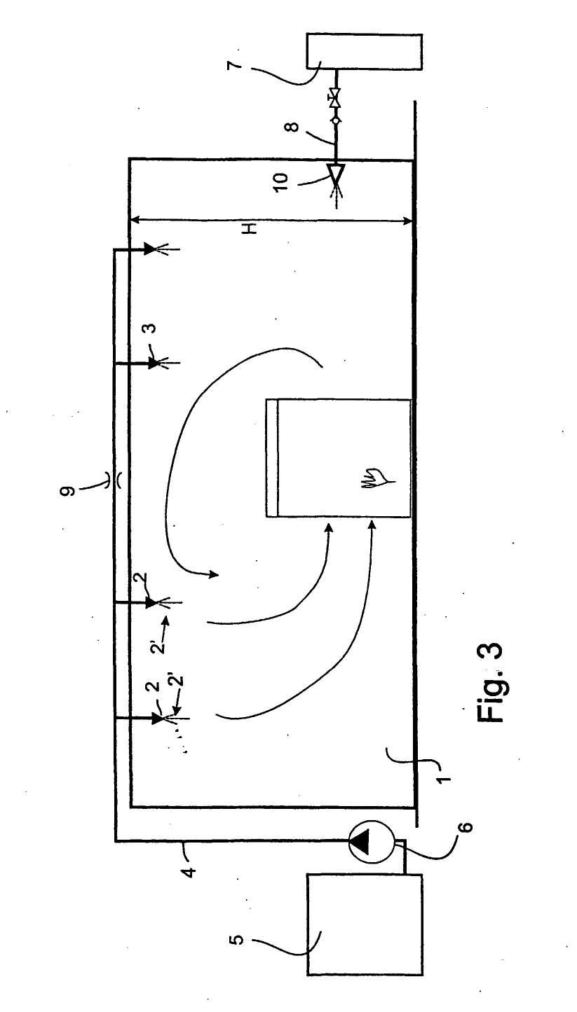

At least a number of the second nozzles 3 are placed in a different part of the space with respect to the first nozzles 2 in the embodiment represented by FIG. 1 and 3, the second nozzles 3 are disposed on the opposite side of the supposed fire seat in relation to the first nozzles 2. The apparatus comprises a pipe system 4, 8 and means for supplying an extinguishing medium into the pipe system via at least one first end and means for supplying a gas into the pipe system via at least one second end so that, at least in part of the pipe system 4, 8, the extinguishing medium and the gas use the same pipe at least in the course of the extinguishing process.

The space 1 is a high space having a height H of at least 3 meters, preferably over 5 meters. The space 1 is closed at least during the fire extinguishing process. The entrances into the space are therefore closed in connection with the fire extinguishing process.

The space 1 comprises at least one open entrance (not shown in the figure) during the fire extinguishing process, in other words, the space is a so-called open space. The fire extinguishing process is preferably efficient enough to allow at least one entrance to be kept at least partially open during the extinguishing process.

According to another embodiment, gas can be sprayed into the space via at least one third nozzle 10, in which case a mist of extinguishing medium is sprayed into the space 1 via at least one first nozzle 2 or via at least one first nozzle 2 and at least one second nozzle 3 in an unevenly distributed manner so that a circulation of the mist of extinguishing medium is created in the space. The pipe systems for the first and the second nozzles may naturally also be separated from each other.

FIG. 3 presents another preferred embodiment of the invention, in which a gas is supplied through one third nozzle 10, which preferably is separate from the pipe system 4 carrying the extinguishing medium, from a gas source 7 via pipe 8. A mist of extinguishing medium is supplied by means of nozzles 2, 3 provided in the upper part of the space. The pipe system is provided with a pressure limiting device, such as e.g. a valve or throttle 9, placed between the first nozzles 2 and the second nozzles 3, so that a circulation of extinguishing medium, represented by arrows in the figure, is produced in the space during the extinguishing process. From the second nozzles 3, a mist of extinguishing medium is sprayed at a lower pressure than from the first nozzles at least at the early stage of the extinguishing process so as to produce the desired circulation of extinguishing medium in the space.

It is obvious to the person skilled in the art that the invention is not limited to the embodiments described above, but that it may be varied within the scope of the claims presented below. Thus, the first nozzles and the second nozzles may also be connected to pipe systems separate from each other, in which case the desired unbalance can be created e.g. by regulating the operating source of extinguishing medium or e.g. by means of valve devices. The first nozzles may also be disposed s in a different way than in the embodiment example. The first nozzles may be arranged in the edge area of the space, preferably in the ceiling or in its vicinity close to the side walls, and the second nozzles in the middle area so as to produce an unbalance and a circulation of extinguishing medium in the space.

1. Fire extinguishing method, especially for relatively high spaces (1), such as the engine rooms of ships, in which method a mist of extinguishing medium and a gas are supplied into the space, characterized in that the mist of extinguishing medium is supplied into the space (1) via at least one first nozzle (2) provided in its upper part, in an unevenly distributed manner so that a circulating motion of the mist of extinguishing medium is created in the space.

2. Method according to claim 1, characterized in that the mist of extinguishing medium, especially liquid mist, is sprayed via at least one first nozzle (2) provided in the upper part of the space (1) and the gas is supplied into the space (1) via at least one second nozzle (3) and/or one third nozzle (10).

3. Method according to claim 1, characterized in that the pressure of the gas supplied into the space (1) is lowered as the extin- guishing process is going on.

4. Method according to claim 1, characterized in that the supply of gas into the space (1) is stopped while the extin-guishing process is going on.

5. Method according to claim 1, characterized in that, as the extinguishing process is going on, liquid mist is supplied into the space (1) via at least one first nozzle and/or second nozzle (2, 3) provided in its upper part, in a more evenly distributed manner than at the first stage.

6. Method according to claim 1, characterized in that the mist of extinguishing medium, especially liquid mist, is sprayed into the space (1) at a high pressure.

7. Method according to claim 1, characterized in that at least a number of the second nozzles (3) are used for supplying liquid mist into the space (1) during the supply of gas and/or after the supply of gas has stopped.

8. Method according to claim 1, characterized in that the liquid for the liquid mist and the gas are fed into the same pipe system (4,8).

9. Method according to claim 1, characterized in that the extinguishing medium is supplied to the nozzles (2,3) in an unevenly distributed manner so that the extinguishing medium is fed to at least one second nozzle (3) at a substantially lower pressure than to at least one first nozzle (2).

10. Method according to 1, characterized in that the gas consists of an inert (non-reactive) gas, nitrogen or incombustible mixed gas.

11. Fire extinguishing apparatus especially for relatively high spaces (1), such as the engine rooms of ships, said apparatus comprising means (4,5, 6) for supplying a fire extinguishing medium to at least one first nozzle (2), from which a mist of fire extinguishing medium is sprayed into the space, characterized in that the at least one first nozzle (2) is disposed in the upper part of the space (1) and the apparatus comprises at least one second nozzle (3,10) disposed in the space for supplying a gas and/or a mist of extinguishing medium into the space so as to allow a circulation of the mist of extinguishing medium to be produced in the space.

12. Fire extinguishing apparatus according to claim 11, characterized in that the first nozzles (2) are disposed in the space (1) in an unsymmetrically distributed manner in at least one vertical crosssection of the space.

13. Fire extinguishing apparatus according to claim 11, characterized in that at least some of the second nozzles (3) are placed in a different part of the space with respect to the first nozzles (2).

14. Fire extinguishing apparatus according to 11, characterized in that the pipe system (4) used for the supply of extinguishing liquid and the pipe system (8) used for the supply of gas are connected to each other.

15. Fire extinguishing apparatus according to 11, characterized in that the space (1) is a high space having a height (H) at least 3 meters, preferably over 5 meters.

16. Fire extinguishing apparatus according to 11, characterized in that the space (1) is closed at least during the fire extinguishing process.

17. Fire extinguishing apparatus according to 11, characterized in that the space (1) comprises at least one entrance that is open during the fire extinguishing process, in other words, that the space is a so-called open space.

18. Fire extinguishing apparatus according to 11, characterized in that at least some of the first nozzles (2) are of a type that produces a concentrated mist of extinguishing medium as a spray that has a good penetrating power.

19. Fire extinguishing apparatus according to 11, characterized in that the space is provided with at least one third nozzle (10) for supplying a gas into the space.

20. Fire extinguishing apparatus according to 11, characterized in that the pipe system (4) is provided with a pressure limiting device, such as e. g. a valve or throttle (9), placed between the first nozzles (2) and the second nozzles (3).
